(19) United States
(12) Patent Application Publication
(10) Pub. No.: US 2004/0247412 A1
(43) Pub. Date: Dec. 9, 2004

(54) Self-drilling blind riveting nut

(76) Inventors: Bernard Reck, Breidenbach (DE); Elmar Schreiter, Schwabach (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/482,329

(22) PCT Filed: Jun. 13, 2002
(86) PCT No.: PCT/EP02/06527

(30) Foreign Application Priority Data
Jun. 26, 2001 (DE) 101306814

(51) Int. Cl. F16B 25/00

(52) U.S. Cl. 411/386

(57) ABSTRACT

The present invention relates to a self-drilling blind rivet nut which is especially suited for fixation in carbon fiber-reinforced plastic sheets. Said blind rivet nut has a drilling crown at its front end facing away from the set head.

The present invention relates to a self-drilling blind rivet nut, comprising a tubular sleeve having an internal thread and including a set head at a front end, and a drilling tool.

Such a self-drilling blind rivet nut is e.g. known from DE 40 03 373 C1. The end of the set mandrel projecting from the set sleeve is there equipped with a drilling tip having a diameter greater than the diameter of the sleeve. In the known riveting nut, the upper part of the rivet sleeve is provided with an internal thread while the lower part of the sleeve facing the drill tip is without a thread. Said threadless part forms the rivet head. The known rivet fastener permits the setting of the blind rivet nut in a single operation without the need for pre-drilling with the help of a separate tool. A drawback is however that the set mandrel has a relatively complicated structure and that the fastener, on the whole, is thus relatively expensive. Moreover, the mandrel remains in the sleeve after the rivet nut has been set.

It is therefore the object of the present invention to provide a self-drilling blind rivet nut of the above-mentioned type which can be produced at low costs on the one hand and can be handled easily on the other hand.

This object is achieved according to the invention in that the front end of the sleeve facing away from the set head is designed as a drilling crown in the manner of a core drill.

The rivet sleeve which is normally produced as an extruded part of steel, aluminum or an alloy thereof permits the integration of the cutters without a separate operation. The manufacture of the blind rivet nut is therefore relatively simple. Furthermore, the same set mandrel can be used as in conventional blind rivet nuts. It is also possible to use a reusable mandrel. The blind rivet nut according to the invention is particularly suited for setting in fiber-reinforced plastic sheets. Such materials tend to tear out during drilling with a solid drill because of the inhomogeneous material structure. With the blind rivet nut according to the invention the set hole is sawn out in the manner of a hole saw, so that the cutting tools are operative exactly at the place of boundary of the set hole. A fraying of the set hole and a weakening of the carrier base material associated therewith is thus avoided. Surprisingly, it has been found that despite the base material of the rivet sleeve, which most of the time consists of aluminum or an aluminum alloy, the drilling crown has a sufficiently long service life. Although the teeth of the drilling crown wear during the drilling operation, which may also lead to a heating up of the rivet sleeve, said heating really supports the drilling operation proper. Nevertheless, it may be of advantage under certain conditions of use when the cutting teeth of the drilling crown are hardened.

Furthermore, it is also advantageous when the wall thickness of the sleeve in the area of the sawtooth-like cutting edges is smaller than in the area of the internal thread of the sleeve. In this way the drilling crown rather operates in the manner of a hole saw than in the manner of a milling cutter. The wall thickness of the sleeve can be adapted to the respective conditions of the material to be riveted. As a rule, attention must just be paid that the area of a thinner wall thickness has at least a height as great as the thickness of the materials to be riveted.

In a preferred embodiment of the present invention, the internal thread extends between the drilling crown and a threadless clamp portion of the blind rivet nut positioned below the set head. It can thereby be ensured that the thread portion available for the screwing in of a later screw bolt remains always the same independently of the material thickness of the sheet material to be riveted.

Depending on the material of the basic material to be riveted and also depending on whether the setting tool is guided by hand or machine, it may be of advantage when the blind rivet nut comprises a set mandrel which comprises a centering tip axially projecting beyond the drilling crown. When the blind rivet nut is mounted, the sheet material to be riveted is thereby first drilled to some degree and then drilled through by the centering tip, whereupon the drilling crown of the rivet sleeve which is equipped with the sawteeth impinges on the sheet material.

Further advantageous designs of the invention are the subject of the remaining subclaims.

An embodiment of the invention will now be explained in more detail with reference to a drawing, in which

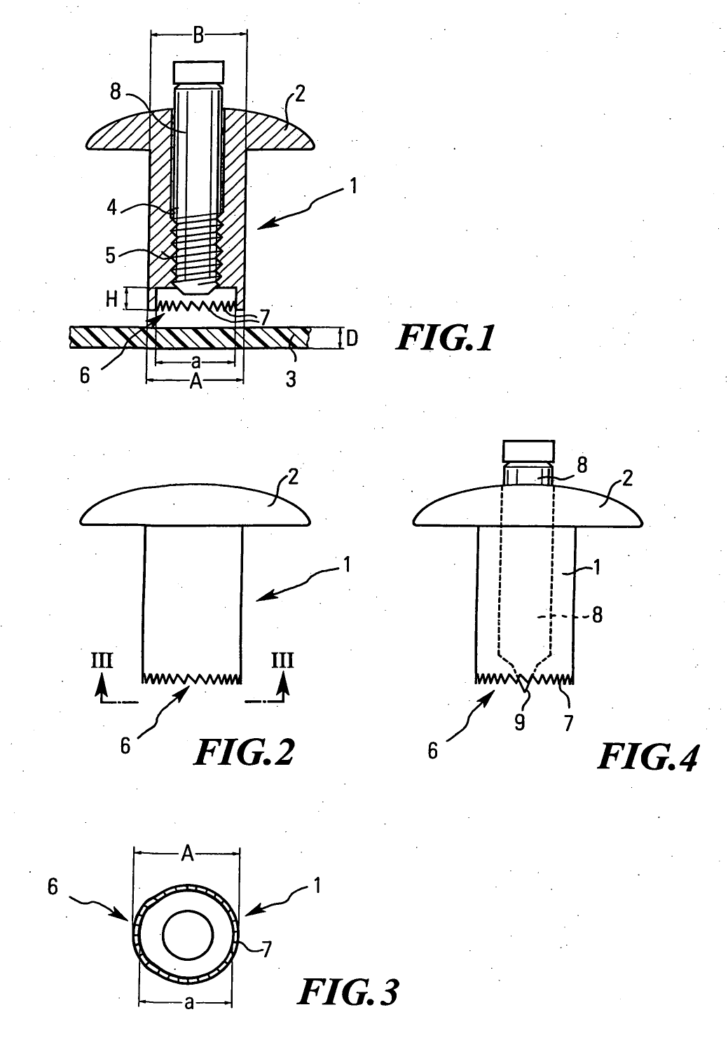

FIG. 1 shows a blind rivet nut of the invention with drilling crown and set mandrel in cross section;

FIG. 2 shows the blind rivet nut of FIG. 1 in a side view;

FIG. 3 shows the blind rivet nut of FIG. 2 in a view from below along line III-III;

FIG. 4 shows a variant of the blind rivet nut of FIG. 1 with a set mandrel having a centering tip; and

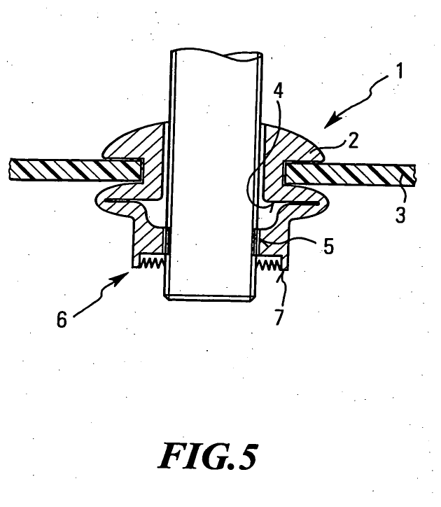

FIG. 5 shows the blind rivet nut in the fixed state with inserted screw bolt.

The drawing shows a blind rivet nut having a rivet sleeve 1 which at a front end carries a set head made integral with the rivet sleeve 1.

A threadless section extends from the set head 2 and has a length depending on the thickness of the sheet material 3 into which the blind rivet nut is to be inserted. The threadless section 4 is then followed by a portion having an internal thread 5. The front end of the rivet sleeve 1 that is opposite to the set head 2 is formed by a drilling crown 6 which consists of sawtooth-like cutters 7 running around the circumference of the rivet sleeve 2. The outer diameter A of the drilling crown 6 is as large as or slightly larger than the outer diameter B of the remaining rivet sleeve 1. By contrast, the inner diameter a of the drilling crown 6 is in the illustrated embodiment larger than the inner diameter of the remaining rivet sleeve. This reduces the wall thickness of the rivet sleeve 1 in the area of the cutters. The height H of the drilling crown 6 is at least as large as the thickness D of the sheet material 3.

FIG. 4 shows a variant of the above-described blind rivet nut in which the set mandrel 8 has a centering tip 9 projecting beyond the drilling crown 6. Said centering tip 9 is formed as a drilling tip in the embodiment as is described here.

The operation and function of the blind rivet nut of the invention shall now be explained in more detail.

Starting from the situation shown in FIG. 1, the blind rivet nut is rotated together with the set mandrel around its own axis, so that the drilling crown 6 dips into the sheet material 3 in the manner of a hole saw. In this process an apertured sheet is sawn out, in this instance from a sheet material consisting of carbon fiber-reinforced plastics, and falls downwards. The setting tool will then push the rivet sleeve 1 downwards until the set head 2 rests on the sheet material. Like in a setting operation with a conventional blind rivet nut, the rivet sleeve is then retained while the set mandrel continues to rotate so that the threadless section 4 is upset. The setting operation can also be carried out through a pulling movement of the screwed-in set mandrel. To this end the setting tool need only be supported on the set rivet head.

The blind rivet nut is then in the position shown in FIG. 5. In this state, a thread bolt can be screwed in like in the case of a conventional blind rivet nut.

The setting of the blind rivet nut according to the variant shown in FIG. 4 is carried out in the same way as described above. However, in contrast to the above-described variant, the centering tip 9, which is formed as a drilling tip, first dips into the sheet material. As a result, the blind rivet nut is already fixed radially, which facilitates the setting of the blind rivet nut with a setting tool held by hand.

1-12. (Canceled).

13. A self-drilling blind rivet nut, comprising:
a tubular sleeve having a set head at a front end, and a drilling tool,
wherein the front end of the tubular sleeve faces away from the set head and is configured as a drilling crown in a core drill.

14. The blind rivet nut according to claim 12, wherein cutting edges of the drilling crown are formed sawteeth running around a circumference of the tubular sleeve.

15. The blind rivet nut according to claim 14, wherein a wall thickness of the tubular sleeve in an area of the sawtooth cutting edges is smaller than in an area of an internal thread of the tubular sleeve.

16. The blind rivet nut according to claim 13, wherein an outer diameter of the tubular sleeve in an area of the drilling crown is larger than or equal to a remaining outer diameter of the tubular sleeve.

17. The blind rivet nut according to claim 13, wherein the tubular sleeve includes an internal thread and the internal thread of the tubular sleeve extends only over part of an axial length of the tubular sleeve.

18. The blind rivet nut according to claim 13, wherein the tubular sleeve includes an internal thread and the internal thread of the tubular sleeve extends between the drilling crown and a threadless clamp region positioned below the set head.

19. The blind rivet nut according to claim 13, wherein the tubular sleeve is formed of a material selected from steel, aluminum, or an aluminum alloy.

20. The blind rivet nut according to claim 14, wherein the sawteeth of the drilling crown is formed of a material of the tubular sleeve.

21. The blind rivet nut according to claim 14, wherein the sawteeth is hardened at least in part.

22. The blind rivet nut according to claim 13, further comprising a set mandrel that during setting of the blind rivet nut comprises a centering tip axially projecting beyond the drilling crown.

23. A method for setting a blind rivet nut according to claim 13, wherein the set mandrel is screwed into the tubular sleeve in one operation, the tubular sleeve is then rotated with the rivet mandrel for drilling a hole, the tubular sleeve is upset with the set mandrel, and the set mandrel is finally screwed out of the riveted rivet nut in a direction opposite to the screw-in direction.

24. The method according to claim 23, wherein a rivet nut is used with a threadless sleeve and an internal thread is formed or cut while the mandrel is screwed into the threadless sleeve.
